(19) United States
(12) Patent Application Publication
(10) Pub. No.: US 2016/0283096 A1
(43) Pub. Date: Sep. 29, 2016

(54) METHOD OF GENERATING A LINK BY UTILIZING A PICTURE AND SYSTEM THEREOF

(71) Applicant: XINYU XINGBANG INFORMATION INDUSTRY CO., LTD., Xinyu City (CN)

(72) Inventors: Xiaohong YAO, Xinyu City (CN); Zhihong ZHOU, Xinyu City (CN)

(21) Appl. No.: 15/008,920

(22) Filed: Jan. 28, 2016

(30) Foreign Application Priority Data
Mar. 24, 2015 (CN) 201510129910.4

(51) Int. Cl. G06F 3/0484

(52) U.S. Cl. CPC G06F 3/04847

(57) ABSTRACT

Disclosed is a method of generating a link by utilizing a picture. The method comprises obtaining, at a server, a picture and setting a link area for the picture; generating code according to shape information of the link area and a coordinate of the link area relative to the picture to create a picture cover layer; and making jumps, for access to different areas of a picture, to links of respective information addresses corresponding to picture cover layers on the different areas. A plurality of advertisements can be presented in one picture, and separation of advertisement from a display can be realized, which saves server's bandwidth and reduces costs for maintaining advertisement links.

### FIELD OF THE INVENTION

The present invention relates to information distribution in the internet, particularly to a method and system for generating information links using images.

### BACKGROUND OF THE INVENTION

Conventionally, a link in a web page is basically in such a manner that one image corresponds to one link or one keyword corresponds to one hyperlink. Both ways have their own shortcomings. Conventional keyword link has only a single appearance and thus needs to be packaged by background pictures for improving its ornamental value. In this way, however, even if the background has a small change, the corresponding code must be modified, which is very troublesome. On the other hand, for the other way that one picture corresponds to one link or one page, it is relatively costly as one picture has only one information page. Since users may be interested in certain part of the picture only, it is desirable to provide a plurality of access entries to users to guide the corresponding data traffic to different service sites. For this purpose, if one picture has one information page, then it is necessary to cut the picture to more images. However, if vast accesses occur, then a large traffic will be consumed and manpower for maintaining a large number of pictures will increase when cutting one picture into more pictures.

### SUMMARY OF THE INVENTION

The present invention intends to solve one or more of the above problems by providing a method and system for generating links from a picture.

According to an aspect of the present invention, a method of generating a link from a picture is provided, wherein the method may be performed by a computer system having a memory and a processor, and the method comprises: obtaining, by the computer system, a picture and setting a link area for the picture; generating code by the processor according to shape information of the link area and a coordinate of the link area relative to the picture to create a picture cover layer; and conducting by the processor, for accesses to different areas of a picture, jumps to links of respective information addresses corresponding to picture cover layers on the different areas.

Through the above method of creating a picture cover layer on the picture, a plurality of information links can be placed in one picture, and the information displaying layer and the picture displaying layer can be separated, which saves bandwidth for a server.

In some embodiments, the picture cover layer may be a link of information address. Thus, the picture cover layer may be created through the following steps: generating link insert code according to a shape information and coordinate of the picture cover layer, and inserting the generated link insert code to a page on which the picture locates to form links of information addresses in different areas of the picture. Thus, it is possible to place a plurality of information address links in one picture.

In some embodiments, the picture cover layer may be a transparent cover layer. Thus, a picture cover layer may be created through the following steps: generating a code by the processor for generation of a transparent cover layer and a positioning code for positioning a link area in the transparent cover layer, and embedding the generated code into a page on which the picture is placed to form a transparent cover layer incorporating different link areas on the picture. Thus, the information displaying layer and the picture displaying layer can be separated completely. Even if loading of the picture displaying layer is not completed, a jump can also be achieved. This increases the conversion rate of the information display, and replacement of pictures can be done freely. As long as the link information does not change, it is not necessary to modify the code, which saves traffic and reduces maintenance costs. Further, when a cursor enters the transparent cover layer by a mouse operation, since the cover layer has been bound to the mouse event, the user's mouse sliding track can be calculated by using the mouse event and sent to a Hadoop collection platform for a more knowledge about users' behaviors as well as increasing the accuracy of the information positioning.

In some embodiments, the process of generating a transparent cover layer for a predetermined display position with fixed width and height may comprise the following steps carried out by the processor: setting width and height of the picture to be equal to width and height of the display position, calculating a coordinate of the picture relative to the page on which the picture is placed, and generating the transparent cover layer according to the coordinate and the width and height of the display position; and the process of positioning the link area on the transparent cover layer may comprise positioning the link area of the picture according to shape information and a coordinate of the link area with respect to the picture in the transparent cover layer, and covering the generated transparent cover layer on a corresponding position of the page which the picture locates.

On the other hand, for a predetermined display position without fixed width and height, the width and height of a container are customized by user. In this case, the process of generating a transparent cover layer may comprise: calculating width and height of the container and a coordinate of the picture with respect to a page which the picture locates, and generating the transparent cover layer according to the width and height of the container and the calculated coordinate; and the process of positioning the link area on the transparent cover layer may comprise: converting the coordinate of the link area with respect to the picture into a dynamic coordinate of the link area according to information of the link area set on the picture and the width and height of the container, embedding the link area into the transparent cover layer according to the width and height of the container and the dynamic coordinate information customized by users, and covering the picture with the generated transparent cover layer.

Accordingly, size of a display position can be customized freely by users, and a link area for a transparent cover can be positioned flexibly according to a specific size of the display position, thus reducing a cost of maintenance.

According to another aspect of the present invention, a system of generating a link of information address using a picture comprises: a displayer for displaying pictures and at least one link areas in each of said pictures; a processor for executing instructions stored in a memory to provide a jump to said link of information address, wherein the system further comprises: a picture layer unit implemented by the processor and configured to display information and provide a link area; a picture link setting unit implemented by the processor and configured to obtain a picture and set a link area for the picture; a picture cover layer generating unit implemented by the processor and configured to generate code according to shape information of the link area and a coordinate of the link area with respect to the picture to create a picture cover layer; a picture covering unit implemented by the processor and configured to cover the picture cover layer on the picture and provide a link of information address for the link area set on the picture; and a page displaying unit implemented by the processor and configured to provide multiple areas corresponding to the picture cover layers for accessing to the picture so that jump to a respective link of information address of one of the multiple areas will be done according to the accessing to the picture.

According to the above system, a picture covering layer is provided to cover a picture so that multiple information links can be placed on one picture and an information display layer can be separated from a picture display layer, thus saving a server's bandwidth.

In some embodiments, the picture cover layer incorporates a link of information address, and the picture cover layer generating unit is further configured to generate link insert code to insert the generated link insert code to a page at which a picture is placed according to the shape information and the coordinate, so as to form a link of information address in different areas of the picture. Accordingly, multiple links of information address can be placed in one picture.

In some embodiments, the picture cover layer is a transparent cover layer, and the picture cover layer generating unit comprises a transparent cover layer generating module and a link area positioning module, the transparent cover layer generating module being implemented by the processor and configured to generate code for generation of the transparent cover layer and the link area positioning module being implemented by the processor and configured to generate position code for positioning link areas at the transparent cover layer so that the generated code can be inserted into a page at which the picture is placed to form the transparent cover layer containing multiple link areas on the picture. Accordingly, the information displaying layer and the picture displaying layer can be separated completely. Even if loading of the picture displaying layer is not completed, a jump can also be achieved. This increases the conversion rate of the information display, and replacement of pictures can be done freely. As long as the link information does not change, it is not necessary to modify the code, which saves traffic and reduces maintenance costs. Further, when a cursor enters the transparent cover layer by a mouse operation, since the cover layer has been bound to the mouse event, the user's mouse sliding track can be calculated by using the mouse event and sent to a Hadoop collection platform for a more knowledge about users' behaviors as well as increasing the accuracy of the information positioning.

In some embodiments, the transparent cover layer generating module may be configured to, for a predetermined display position with fixed width and height, set width and height of the picture to be width and height of the display position, calculate a coordinate of the picture with respect to the page at which the picture is placed, and generate the transparent cover layer according to the calculated coordinate and the width and height of the display position; and the link area positioning module may be configured to, for a predetermined display position with fixed width and height, position the link area of the picture according to shape information and a coordinate of the link area with respect to the picture in the transparent cover layer and place the generated transparent cover layer over a corresponding position of the page at which the picture is placed.

On the other hand, the transparent cover layer generating module may be configured to, for a predetermined display position without fixed width and height which are customized by a user, calculate width and height of a container and a coordinate of the picture with respect to a page at which the picture is placed, and generate the transparent cover layer according to the width and height of the container and the calculated coordinate; and the link area positioning module may be configured to convert a coordinate of the link area with respect to the picture into dynamic coordinate information of the link area according to information of the link area set on the picture, and insert the link area according to width and height of the container and the dynamic coordinate information, and insert the generated transparent cover layer into the picture. Accordingly, a size of the exhibition position can be defined freely by a user, and a transparent cover layer may position a link area flexibly according to size of a picture exhibition position, thus cutting down maintenance cost.

Accordingly, separation of advertisement from a display can be achieved through the method and system provided above, which increases the conversion rate of the advertisement, saves server's bandwidth and reduces costs for maintaining advertisement links.

### BRIEF DESCRIPTION OF THE DRAWINGS

FIG. 1 is a block diagram which schematically shows a system being capable of generating a link using a picture according to an embodiment of the invention;

FIG. 2 is a flow diagram for a method of generating a link using a picture according to one embodiment of the present invention;

FIG. 3 is a flow diagram for a method of generating a link using picture according to another embodiment of the present invention;

FIG. 4 is a structural schematic diagram for an advertising space of generating a link using picture of one embodiment of the present invention;

FIG. 5 is a schematic diagram showing a process for generating the advertisement code in the method as shown in FIG. 2;

FIG. 6 is a schematic diagram showing a process for generating the transparent cover layer according to the method as shown in FIG. 3; and

FIG. 7 is a schematic diagram showing a process for generating the transparent cover layer according to the method as shown in FIG. 3.

### DETAILED DESCRIPTION

A computer system for generating a link using a picture according to the present invention may be implemented via personal computers, mobile devices, tablet computers, televisions, appliances, and the like. A picture from which links are to be generated can be presented by web pages, television shows, an Intelligent Agent user interface, mobile applications (including third party apps), and the like. Accordingly, the system may present pictures and links in many ways.

Various implementations of the invention will now be described. The following description provides specific details for a thorough understanding and an enabling description of these implementations. A skilled in the art will understand that the invention may be practiced without some details disclosed herein. Moreover, some well-known structures or functions will not be illustrated or described to their details to avoid unnecessarily obscuring the substantive features which are embodied in the relevant description of various implementations. Also, the terminology used throughout the whole description is intended to be interpreted in its broadest reasonable manner, though it may be used in conjunction with certain specific embodiments of the invention.

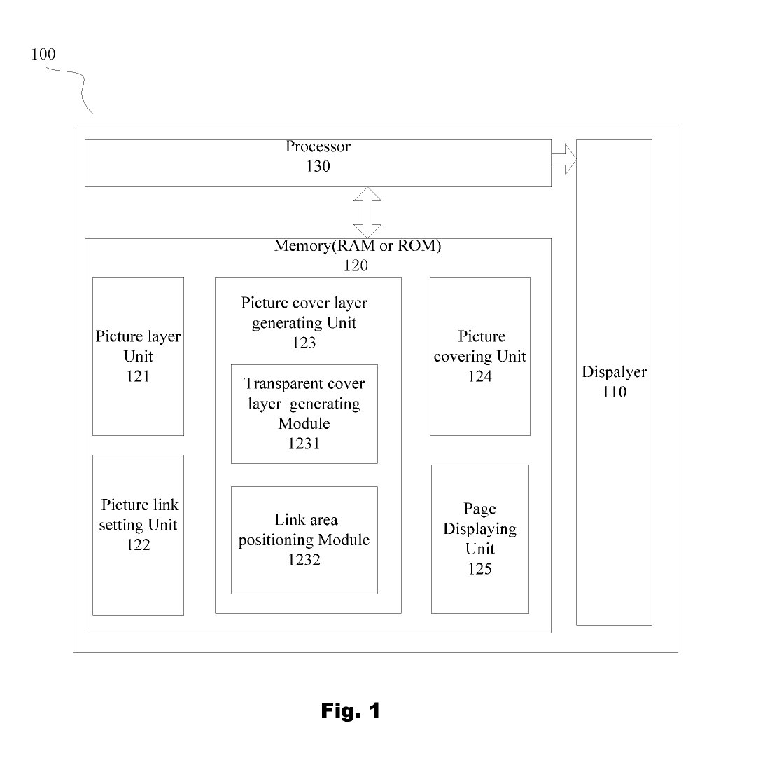

FIG. 1 and the following discussion provide a brief, general description of a suitable computing environment 100 in which a system for generating a link from a picture can be implemented. Although not required, aspects and implementations of the invention may be described in the general context of computer-executable instructions, such as routines executed by a general-purpose computer or a mobile device, e.g., a personal computer or smart phone. Those skilled in the art will appreciate that the invention can be practiced with other computer system configurations, including Internet appliances, set-top boxes, televisions, hand-held devices, wearable computers, vehicle computer systems, radios, household appliances (especially ones connected to the Internet), gaming consoles, mobile phones, laptops, netbooks, tablets, multiprocessor systems, microprocessor-based systems, minicomputers, mainframe computers, or the like. The invention can be embodied in a special purpose computer or data processor that is specifically programmed, configured, or constructed to perform one or more of the computer-executable instructions explained in detail below. Indeed, the terms “computer” or “computing system” as used generally herein, refer to devices that have a processor and non-transitory memory, like any of the above devices, as well as any data processor or any device capable of communicating with a network, including consumer electronic goods such as gaming devices, cameras, or other electronics having a data processor and other components, e.g., network communication circuitry. Data processors may include programmable general-purpose or special-purpose microprocessors, programmable controllers, application-specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium or non-transitory medium for data. Software may include one or more program modules, which include routines, programs, objects, components, data structures, and so on that perform particular tasks or implement particular abstract data types.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described below may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the art will recognize that portions of the invention may reside on a server computer, while corresponding portions reside on a client computer. Data structures and transmission of data particular to aspects of the invention are also encompassed within the scope of the invention.

Referring to the example of FIG. 1, a block diagram of a system 100 is shown which is capable of generating a link using a picture according to an embodiment of the invention. As shown in FIG. 1, the system 100 comprises: a displayer 110 for displaying pictures and at least one link areas in each of said pictures; a memory 120 for storing instructions which can be executed by a processor 130 to implement following units: a picture layer unit 121 configured to display information and provide a link area, a picture link setting unit 122 configured to obtain a picture and set a link area for the picture, a picture cover layer generating unit 123 configured to generate code according to shape information of the link area and a coordinate of the link area with respect to the picture to create a picture cover layer, a picture covering layer unit 124 configured to cover the picture cover layer on the picture and provide a link of information address for the link area set on the picture; and a page displaying unit 125 configured to provide multiple areas corresponding to the picture cover layers for accessing to the picture so that jump to a respective link of information address of one of the multiple areas will be done according to the accessing to the picture. The processor 130, upon executing the instructions, provides a jump to said link of information address.

Moreover, the picture cover layer generating unit 123 may comprise two modules: a transparent cover layer generating module 1231 which is configured to generate code for generation of the transparent cover layer and a link area positioning module 1232 which is configured to generate position code for positioning link areas at the transparent cover layer so that the generated code can be inserted into a page at which the picture is placed to form the transparent cover layer containing multiple link areas on the picture.

In other embodiments, the transparent cover layer generating module 1231 is configured to, for a predetermined display position with fixed width and height, set width and height of the picture to be width and height of the display position, calculate a coordinate of the picture with respect to the page at which the picture is placed, and generate the transparent cover layer according to the calculated coordinate and the width and height of the display position; and the link area positioning module 1232 is configured to, for a predetermined display position with fixed width and height, position the link area of the picture according to shape information and a coordinate of the link area with respect to the picture in the transparent cover layer and place the generated transparent cover layer over a corresponding position of the page at which the picture is placed.

Now, in a preferred embodiment, the transparent cover layer generating module 1231 is configured to, for a predetermined display position without fixed width and height which are customized by a user, calculate width and height of a container and a coordinate of the picture with respect to a page at which the picture is placed, and generate the transparent cover layer according to the width and height of the container and the calculated coordinate; and the link area positioning module 1232 is configured to convert a coordinate of the link area with respect to the picture into dynamic coordinate information of the link area according to information of the link area set on the picture, and insert the link area according to width and height of the container and the dynamic coordinate information, and insert the generated transparent cover layer into the picture.

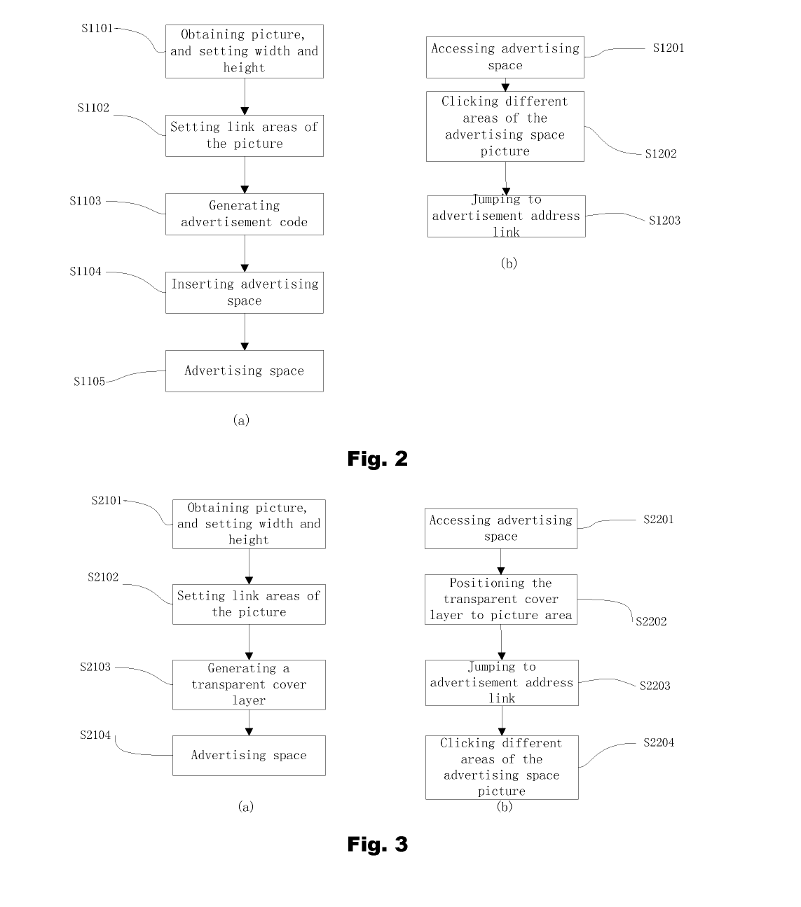

FIG. 2 schematically shows a process which may be implemented by the system 100 discussed above for generating a link by utilizing picture to access the information displaying area according to an embodiment of the present invention. In this embodiment, an advertising space is shown as an example of the information displaying area. FIG. 2 (a) is a schematic diagram of a process for forming the advertising space and FIG. 2(b) is a schematic diagram of a process for accessing advertising space by users.

As shown in FIG. 2(a), the process of creating the information displaying space (advertising space) is as follows.

Step S1101: obtaining a picture, and setting a width and height of the picture.

An advertising system is deployed in an advertising management server and a lot of picture addresses are stored in the advertisement system. When it is necessary to generate an advertising space, a processor of the advertising management server operates to first obtain the address of the picture in which the advertising space is contained from the advertisement system, renders the picture, and sets the picture's width and height. After the width and height of the advertising space are determined, the width and height of the picture are set according to the width and height of the advertising space. If the width and height of the advertising space are not determined, then the width and height of the picture are considered as the default width and height of the advertising space.

Step S1102: setting link areas in the picture.

An area in which a link is to be inserted is obtained through a drag of mouse on the picture, and adjusting the drag area, so that the area can fully cover a portion of the picture in which an advertisement link is to be set. Then, a coordinate of the drag area with respect to the picture (i.e., the upper left corner of the picture being the origin, a relative offset in a horizontal rightward x-axis direction and a vertical downward y-axis direction) at which the drag area is located is obtained through a mouse event, with a shape information of the drag area being recorded. The shape of drag area may be circular shape (such as a circular or an elliptical, a quadrangle (such as a square or a rectangular), or other polygons.

Step S1103: generating advertisement code.

According to the origin position of the picture and the drag information, i.e., the coordinate of the drag area with respect to the picture in which the drag area is located and the shape information of the drag area, a position at which the advertisement link area is to be inserted is calculated and determined, and a Javasrcipt template code for generating and positioning the link area is generated. Then, advertisement codes are generated for the pages to be incorporated with advertisements according to the path of the template code.

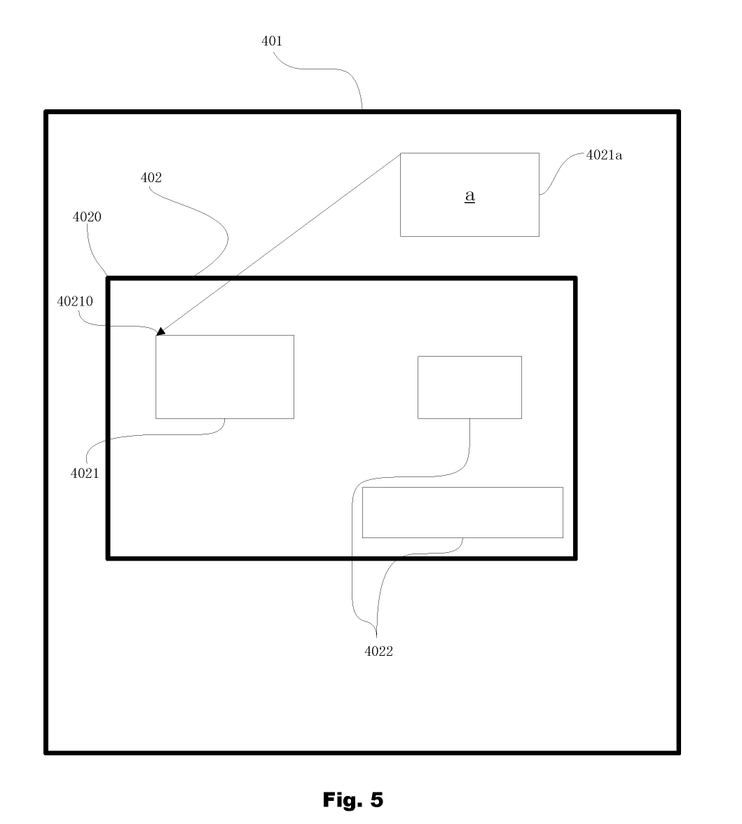

For example, as shown in FIG. 5, a rectangular area 4021 of which the width and height is 20×10 is obtained by dragging on the picture 402. A coordinate point 40210 on the displayed picture is captured by a mouse event to which the mouse is bound at the time of dragging, which is x=30 and y=30, while a coordinate of the origin 4020 at which the picture 402 inserted in page 401 is x=330 and y=330. According to the relative coordinate axes selected in step S 1102, the insert position of the link area in page 401 is a rectangular area 4021 with a coordinate x=360, y=300 and a width of 20 and a height of 10 (20×10). The generated Javascript template code draws a container layer 4021a with the width and height of 20×10 by Javascript script. The container layer 4021a is set as a link pattern, and link information address is assigned for the container layer. Then the container layer 4021a is positioned in advertisement link area according to the coordinate of x=360, y=300. For multiple drag areas 4022 on a picture, each drag area 4022 generates a Javascript template code. All the Javascript template code addresses are combined to form a final advertisement code.

Step S1104: inserting advertising space.

The generated advertisement code is inserted into the page at which the advertising space is located. Then, an advertisement link address is loaded using the Javascript template code for generating and positioning the link areas provided in the advertisement code, thereby completing the insertion of the advertisement link.

Step S1105: Forming the advertising space after the insertion of advertisement links so that the picture displayed in a webpage is an advertising space picture containing information of multiple link addresses.

Through the above steps, the advertising space picture containing a plurality of advertisement links is formed on a webpage. Users can access the advertising space via page browser.

Referring to FIG. 2 (b), an example of process of accessing an advertising space by users via a page browser is described as follows.

Step S1201: a user opens the browser to access the advertising space on the page.

Step S1202: the user clicks an area of the advertising space picture in which links to addresses of advertisement information are embedded.

Step S1203: an advertisement information is rendered to the user through a jump to a corresponding advertisement address link through the links to the address of information which have been embedded in the different areas of the picture.

FIG. 3 schematically shows a method of generating a link by utilizing picture according to another embodiment of the present invention. FIG. 3 (a) is a diagram of a process of forming the advertising space and FIG. 3 (b) is a diagram of a process of accessing advertising space by users. As shown in FIG. 3 (a), the method comprises:

Step S2101: obtaining a picture, and setting width and height of the picture.

A lot of picture addresses are stored in an advertisement system of an advertising management server. When an advertising space is to be generated, the advertising management server first obtains the picture which contains the advertising space from the advertisement system, and sets the picture's width and height. After the width and height of the advertising space are determined, the width and height of the picture are set according to the width and height of the advertising space. On the other hand, if the width and height of the advertising space are not determined, the width and height of the picture are adopted as a default width and height of the advertising space.

Step S2102: setting link areas of the picture.

An area in which a link is to be inserted is set by using a mouse to drag on the picture. Then the drag area is adjusted so that it can exactly cover the picture area which is intended to provide advertising links. A coordinate of the drag area is obtained with respect to the picture in which the drag area is located via a mouse event (i.e., a relative shift in x-axis and y-axis directions), and shape information of the drag area is recorded. The shape of the drag area can be round, elliptical, trilateral, quadrangle, or other polygonal.

Step S2103: generating a transparent cover layer.

The generation of a transparent cover layer is a dynamic process. Namely, it is necessary to consider two different types of advertisements: one has the determined width and height of advertising space; the other has undetermined width and height of advertising space but the width and height of container can be customized by users.

For the first type of advertising space, it is firstly calculated for the relative coordinate of the advertisement picture on the page at which the advertisement picture is located. According to the relative coordinate and width and height of the advertising space, code for generating the transparent cover layer are generated, and then Javascript script code for positioning the picture area on the transparent cover layer is generated according to the shape information of the pictures link area and a coordinate of picture link area with respect to the picture.

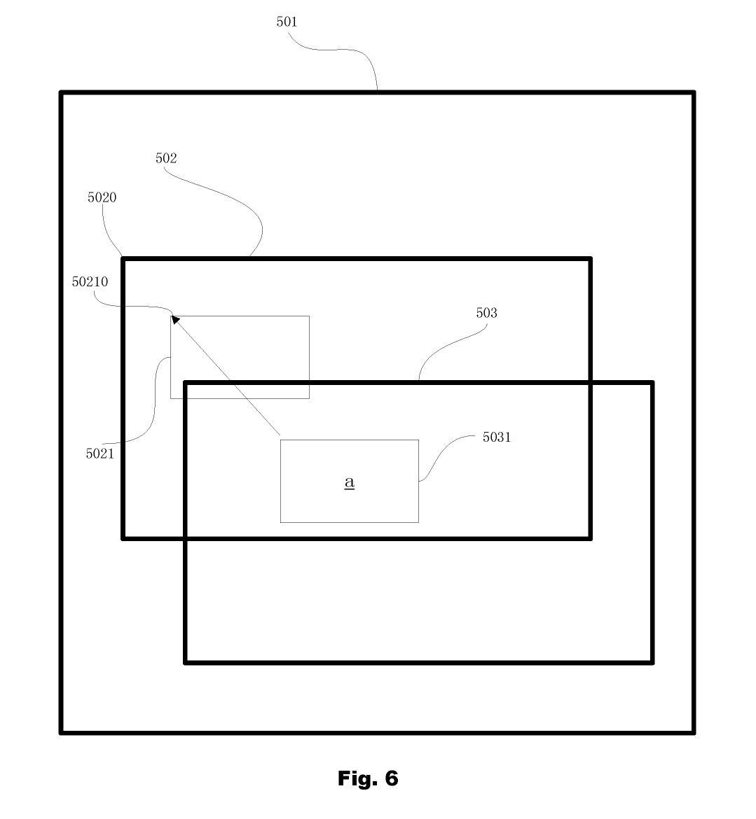

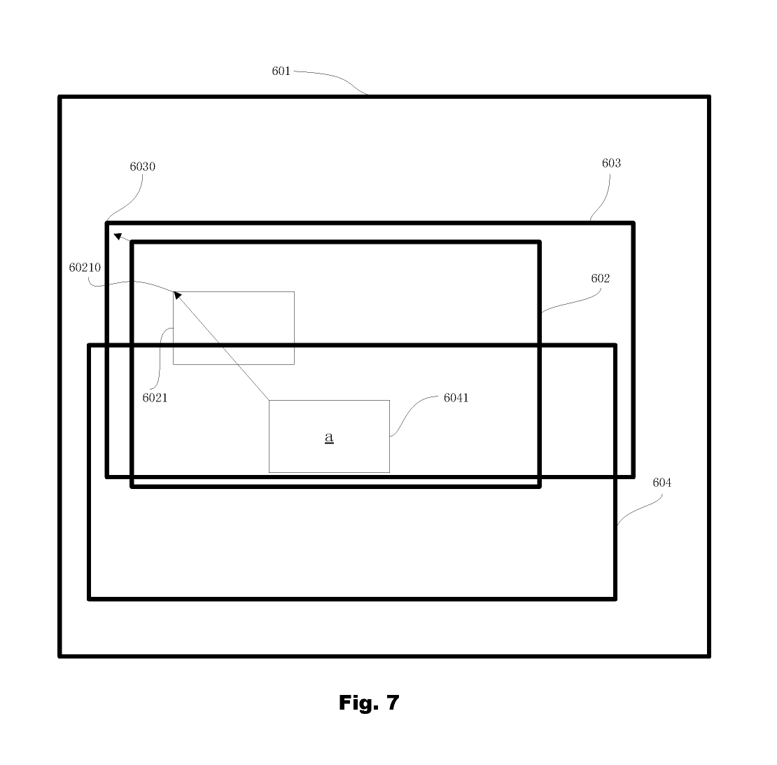

For example, assume that the size of the determined advertisement space is 200×200. As shown in FIG. 6, the width and height of the advertisement picture 502 is set to be 200×200. In step S2102, a rectangular link area 5021 with a width and height of 40×20 and a relative position coordinate 50210 of x=15, y=15 is obtained on the picture 502 by a mouse dragging. The position coordinate of the origin 5020 inserted in page 501 by picture 502 is x=330, y=330. First, Javascript code for generating a transparent layer 503 with width and height of 200×200 and for overlaying picture 502 with transparent layer 503 is generated. Then the coordinate (x=345, y=315) of the link area on the web page 501 is calculated according to the coordinate of the picture origin 5020 and the relative coordinate 50210 of the link area. According to shape information of the link area, i.e., a rectangular area with width and height of 40 X 20, and the position of coordinate (x=345, y=315) in the web page, a link 5031 is generated on the transparent cover layer 503 according to the position of the link area, and its style is set as the shape of the link area, thus completing the generation of the Javascript script code for positioning links area.

For the second type of advertisement, the width and height of the container is calculated automatically at first, and then code for generating the transparent cover layer is created according to a width and height of the container and a relative coordinate of the advertisement picture with respect to the page in which the picture is located. Thereafter, according to the width and height of the container, coordinate and shape information of the link area which have been set, a dynamic coordinate of the picture link area with respect to the advertisement picture at which the picture link area is located is calculated. Finally, Javascript script code for inserting picture link area into the transparent cover layer is generated according to the dynamic coordinate and the width and height of container.

For example, as shown in FIG. 7, assume that the picture 602 has a width and height as 200×200. In Step S2102, a rectangular link area 6021 with width and height of 40×20 and a relative coordinate position of 60210 x=15, y=15, is obtained by dragging on the picture 602, and width and height of the container 603 are defined by the user.

In particular, firstly, Javascript code for automatically calculating the width and height of the container 603 is generated. When the browser is started, the width and height (w×h) of the container 603 can be obtained according to this loaded Javascript code and the size of advertisement picture 602 can be self-adapted in proportion based on the width and height of container 603. Then, a transparent layer 604 with the width and height of w×h is generated accordingly and Javascript code for overlaying picture 602 with transparent layer 604 are created according to a position coordinate of the origin 6030 of container 603 on page 601 at which the container is located. Assuming that the coordinate of the origin position 6030 of container 603 which is inserted in the page is x=330, y=330, the actual dynamic coordinate position x1=x* (h/200), y1=y*(w/200) of the link area with respect to the advertisement picture on page 601 is calculated according to the width and height of the container 603, the width and height of advertisement picture 602 and relative coordinate 60210 of the link area. Then, according to shape information of the link area, that is, the rectangular area with the width and height of 40×20, and the coordinate position x1=330+15*(h/200), y1=330−15*(w/200) of page 601, a link 6041 on the position of the link area is generated, with its style being set as the shape of the link area, thereby completing the generation of Javascript script code for positioning the link area position.

Step S2104: inserting Javascript script created in step S2103 on the page at which the advertising space is located to form the advertising space.

Thus, a picture advertising space comprising a plurality of link areas and having a picture layer overlaid with a transparent cover layer is formed, enabling the user to access the advertising space through a page browser.

Referring to FIG. 3 (b), a process of accessing an advertising space by users via a webpage browser is described as follows:

Step S2201: a user starts the browser to access the advertising space on a webpage.

Step S2202: a transparent cover layer is located to a picture area by the webpage through the code in the embedded Javascript script for positioning the picture areas.

Step S2203: the user clicks different areas of advertising space in the picture.

Step S2204: skip to a corresponding advertisement page via the information address links on the transparent layer to display advertisement information to the user.

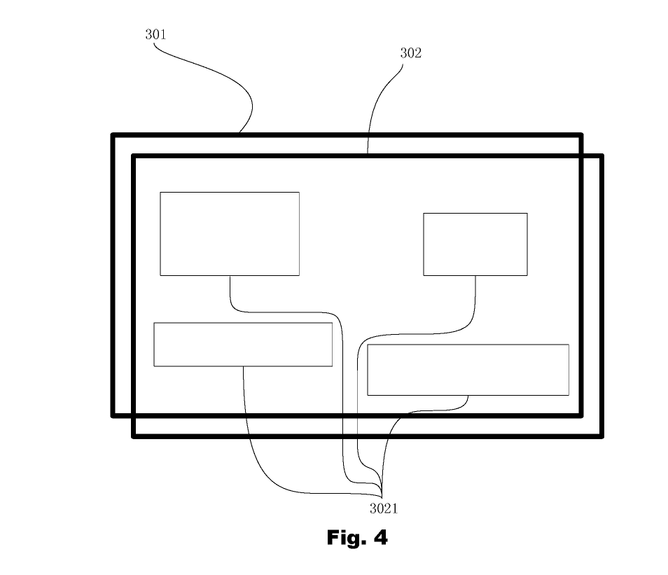

FIG. 4 schematically shows an example of a picture advertising space formed according to an embodiment of the present invention, which comprises a picture layer 301 for displaying information, a picture cover layer 302 for providing advertisement links through advertisement link addresses embedded in a link area 3021. When a user visits such a webpage and find an interesting advertisement on the picture layer 301, the user can access a corresponding advertisement page through the information link set in the link area 3021 on the picture cover layer 302 by a click operation.

The picture cover layer 302 can be realized through conventional information address link or can adopt the transparent cover layer in the embodiment described above in conjunction with FIG. 3. By using the transparent cover layer, advertisement can be separated from display so that a skip to the advertisement page can be realized even though the loading of the picture layer 301 has not been finished, which improves an advertisement conversion rate. The conversion rate in this application refers to a ratio between times of clicks on advertisements by users and the total number of clicks on promotion information, which can be expressed as: Conversion rate=(number of clicks/amount of clicks)*100%. For example, ten users watch a result of a search promotion, and five of them click the result of the promotion which generate jumps to a target link address, after which two of them perform subsequent acts of conversion, i.e., click the advertising space picture of the target link address, then the conversion rate of the promotion result is (2/5)*100%=40%.

Moreover, as long as the position of the link area 3021 does not change, any modification to or replacement of picture layer 301 will not affect advertisement link of the picture cover layer 302. It is not necessary for picture cover layer 302 to change according to the change of the picture layer 301, but is only necessary to perform adjustment of the advertisement link according to a change of link area 3021. In the meantime, file format of the picture layer 301 can also be elected freely. For example, svg format may be used for saving traffic. Thus, the present invention saves server's bandwidth and reduces maintenance costs.

The above description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

It should be noted that, unless the context clearly requires otherwise, throughout the description and the claims, the words “comprise,” “comprising,” and the like are to be construed in an inclusive sense, as opposed to an exclusive or exhaustive sense. Additionally, the words “herein,” “above,” “below,” and words of similar import, when used in this application, refer to this application as a whole and not to any particular portions of this application. Where the context permits, words in the above description using the singular or plural number may also include the plural or singular number respectively. The word “or,” in reference to a list of two or more items, covers all of the following interpretations of the word: any of the items in the list, all of the items in the list, and any combination of the items in the list.

As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above detailed description section explicitly defines such terms. Accordingly, the actual scope of the invention encompasses not only the disclosed examples, but also all equivalent ways of practicing or implementing the invention under the claims.

Certain aspects of the invention are presented below in certain claim forms, but the applicant contemplates the various aspects of the invention in any number of claim forms. Accordingly, the applicant reserves the right to pursue additional claims after filing this application to pursue such additional claim forms, in either this application or in a continuing application.

We claim:

1. A method of generating a link of information address by utilizing a picture, wherein the method is performed by a computer system having a memory and a processor, the method comprising:
obtaining by the processor a picture and setting a link area for the picture;
generating code by the processor according to shape information of the link area and a coordinate of the link area relative to the picture to create a picture cover layer; and
making jumps by the processor to links of respective information addresses corresponding to picture cover layers on different areas of the picture for accessing to the different areas.

2. The method of claim 1, wherein the picture cover layer comprises a link of information address, and said step of generating code and creating picture cover layer comprises generating link insert code according to the shape information and the coordinate, and inserting the generated link insert code to a page on which the picture is placed to form links of information addresses in different areas of the picture.

3. The method of claim 1, wherein the picture cover layer is a transparent cover layer, and said step of generating code and creating picture cover layer comprises generating code for generation of the transparent cover layer and code for positioning link area on the transparent cover layer, and embedding the generated code into a page which the picture locates so as to form the transparent cover layer which incorporates different link areas on the picture.

4. The method of claim 3, wherein
for a predetermined display position with fixed width and height,
said step of generating transparent cover layer comprises
setting width and height of the picture to be equal to width and height of the display position, calculating a coordinate of the picture relative to the page on which the picture is placed, and generating the transparent cover layer according to the coordinate and the width and height of the display position; and
said process of positioning the link area on the transparent cover layer comprises
positioning the link area of the picture according to shape information and a coordinate of the link area with respect to the picture in the transparent cover layer, and covering the generated transparent cover layer on a corresponding position of the page which the picture locates; and
for a predetermined display position without fixed width and height, the width and height of a container are customized by user, and
said process of generating a transparent cover layer comprises
calculating width and height of the container and a coordinate of the picture with respect to a page which the picture locates, and generating the transparent cover layer according to the width and height of the container and the calculated coordinate; and
the process of positioning the link area on the transparent cover layer comprises
converting the coordinate of the link area with respect to the picture into a dynamic coordinate of the link area according to information of the link area set on the picture and the width and height of the container, embedding the link area into the transparent cover layer according to the width and height of the container and the dynamic coordinate information customized by users, and overlaying the picture with the generated transparent cover layer.

5. A system of generating a link of information address using a picture comprises:
a displayer for displaying pictures and at least one link areas in each of said pictures;
a memory for storing instructions; and
a processor for executing instructions stored in the memory to provide a jump to said link of information address, wherein the system further comprises;
a picture layer unit, implemented by the processor and configured to display information and provide a link area;
a picture link setting unit, implemented by the processor and configured to obtain a picture and set a link area for the picture;
a picture cover layer generating unit implemented by the processor and configured to generate code according to shape information of the link area and a coordinate of the link area with respect to the picture to create a picture cover layer;
a picture covering unit, implemented by the processor and configured to cover the picture cover layer on the picture and provide a link of information address for the link area set on the picture; and
a page displaying unit implemented by the processor and configured to provide multiple areas corresponding to the picture cover layers for accessing to the picture so that jump to a respective link of information address of one of the multiple areas will be done according to an access to the picture.

6. The system of claim 5, wherein the picture cover layer is a transparent cover layer, and picture cover layer generating unit comprises:
a transparent cover layer generating module, configured to generate code for generation of the transparent cover layer ;and
a link area positioning module, configured to generate position code for positioning link areas at the transparent cover layer so that the generated code can be inserted into a page at which the picture is placed to form the transparent cover layer containing multiple link areas on the picture.

7. The system of claim 6, wherein the transparent cover layer generating module is configured to, for a predetermined display position with fixed width and height, set width and height of the picture to be width and height of the display position, calculate a coordinate of the picture with respect to the page at which the picture is placed, and generate the transparent cover layer according to the calculated coordinate and the width and height of the display position; and
the link area positioning module is configured to, for a predetermined display position with fixed width and height, position the link area of the picture according to shape information and a coordinate of the link area with respect to the picture in the transparent cover layer and place the generated transparent cover layer over a corresponding position of the page at which the picture is placed.

8. The system of claim 7, wherein the transparent cover layer generating module is configured to, for a predetermined display position without fixed width and height which are customized by a user, calculate width and height of a container and a coordinate of the picture with respect to a page at which the picture is placed, and generate the transparent cover layer according to the width and height of the container and the calculated coordinate; and the link area positioning module is configured to convert a coordinate of the link area with respect to the picture into dynamic coordinate information of the link area according to information of the link area set on the picture, and insert the link area according to width and height of the container and the dynamic coordinate information, and insert the generated transparent cover layer into the picture.

9. A computer-readable storage device carrying instructions for performing a method of generating a link of information address by utilizing a picture, comprising:
obtaining a picture and setting a link area for the picture;
generating code according to shape information of the link area and a coordinate of the link area relative to the picture to create a picture cover layer; and
making jumps to links of respective information addresses corresponding to picture cover layers on different areas of the picture for accessing to the different areas.

10. The computer-readable storage device of claim 9, wherein the picture cover layer comprises a link of information address, and said step of generating code and creating picture cover layer comprises generating link insert code according to the shape information and the coordinate, and inserting the generated link insert code to a page on which the picture is placed to form links of information addresses in different areas of the picture.

11. The computer-readable storage device of claim 9, wherein the picture cover layer is a transparent cover layer, and said step of generating code and creating picture cover layer comprises generating code for generation of the transparent cover layer and code for positioning link area on the transparent cover layer, and embedding the generated code into a page which the picture locates so as to form the transparent cover layer which incorporates different link areas on the picture.

12. The computer-readable storage device of claim 11, wherein
for a predetermined display position with fixed width and height,
said generating transparent cover layer comprises
setting width and height of the picture to be equal to width and height of the display position, calculating a coordinate of the picture relative to the page on which the picture is placed, and generating the transparent cover layer according to the coordinate and the width and height of the display position; and
said positioning the link area on the transparent cover layer comprises
positioning the link area of the picture according to shape information and a coordinate of the link area with respect to the picture in the transparent cover layer, and covering the generated transparent cover layer on a corresponding position of the page which the picture locates; and
for a predetermined display position without fixed width and height, the width and height of a container are customized by user, and
said generating a transparent cover layer comprises
calculating width and height of the container and a coordinate of the picture with respect to a page which the picture locates, and generating the transparent cover layer according to the width and height of the container and the calculated coordinate; and
said positioning the link area on the transparent cover layer comprises converting the coordinate of the link area with respect to the picture into a dynamic coordinate of the link area according to information of the link area set on the picture and the width and height of the container, embedding the link area into the transparent cover layer according to the width and height of the container and the dynamic coordinate information customized by users, and overlaying the picture with the generated transparent cover layer.
